(19) United States
(12) Patent Application Publication
(10) Pub. No.: US 2024/0392062 A1
(43) Pub. Date: Nov. 28, 2024

(54) HIGHLY BRANCHED POLYLACTIDE RESIN AND METHOD FOR PREPARING THE SAME

(71) Applicant: LG CHEM, LTD., Seoul (KR)

(72) Inventors: Won Hee WOO, Daejeon (KR); Si Jung PARK, Daejeon (KR); Heung Yeal CHOI, Daejeon (KR); Wan Kyu OH, Daejeon (KR)

(21) Appl. No.: 18/689,381

(22) PCT Filed: May 26, 2023
(86) PCT No.: PCT/KR2023/007268

§ 371 Date: Mar. 5, 2024

(30) Foreign Application Priority Data
Jun. 7, 2022 (KR) 10-2022-0069135
May 24, 2023 (KR) 10-2023-0066674

(51) Int. Cl. C08G 63/08; C08G 63/91; C08G 101/00; C08K 5/09; C08K 5/1515; C08K 5/50

(52) U.S. Cl. CPC C08G 63/08; C08G 63/912; C08K 5/09; C08K 5/1515; C08K 5/50; C08G 2101/00; C08G 2230/00

(57) ABSTRACT

A polylactide resin composition that includes a specific branching agent, a phosphorus compound, an organic acid anhydride, and a polylactide resin, resulting in a highly branched polylactide resin, which had not been previously achieved, is possible, exhibiting improved physical properties, especially melt strength, are improved compared to conventional polylactide resins, and it can be applied in processes that were difficult to apply conventional polylactide resins, such as expanded foam. The branching agent is a compound of Chemical Formula 1:

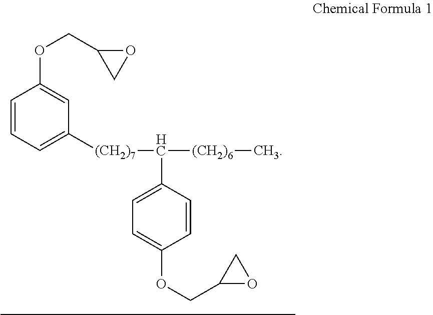

### CROSS-REFERENCE TO RELATED APPLICATION(S)

This application is a National Stage Application of International Application No. PCT/KR2023/007268 filed on May 26, 2023, which claims priority to and claims the benefit of Korean Patent Application No. 10-2022-0069135 filed on Jun. 7, 2022 and Korean Patent Application No. 10-2023-0066674 filed on May 24, 2023 in the Korean Intellectual Property Office, the disclosures of which are incorporated herein by reference in their entirety.

### TECHNICAL FIELD

The present disclosure relates to a polylactide resin composition, and a highly branched polylactide resin prepared therefrom, and a method for preparing the same.

### BACKGROUND

Conventional petroleum-based plastic materials do not naturally decompose, which causes serious environmental pollution. Thus, finding a material to replace them is the top priority research issue in recent years. In particular, plastic foam is widely used as a cushioning material for packaging, but in the case of EPS (Expanded polystyrene) which is most frequently used in the art, it not only does not decompose, but also causes environmental pollution such as generating toxic gases during combustion.

Polylactide (or polylactic acid; PLA) resin, which is a promising alternative to petroleum-based plastic materials, is prepared based on biomass materials, and is an eco-friendly material which emits less global warming gas carbon dioxide during the production process, and is degraded by a specific temperature and composting facility. In addition, the polylactide resin has advantages that it is inexpensive compared to other biodegradable polymers and has high tensile strength and modulus properties.

However, the polylactide resin has disadvantages that it has low thermal stability and impact resistance, slow crystallization rate, and especially low melt strength, making it difficult to use for foam applications. Thus, various methods are known to improve the melt strength of polylactide resin. As an example, a method of increasing LCB (long chain branch) of the polylactide resin to perform branching is known.

Although various branching agents that can be applied to polylactide resins have been known in the past, they have limitations in highly branching polylactide resins. Therefore, the present inventors have found that by using a specific branching agent and anhydride-based compound in the polylactide resin as will be described later, a high degree of branching of the polylactide resin, which has not been achieved hitherto, is achieved, and completed the present disclosure.

### DETAILED DESCRIPTION OF THE INVENTION

### Technical Problem

It is an object of the present disclosure to provide a polylactide resin composition for preparing a highly branched polylactide resin.

It is another object of the present disclosure to provide a highly branched polylactide resin prepared from the polylactide resin composition, and a method for preparing the same.

### Technical Solution

In order to achieve the above objects, according to one aspect of the present disclosure, provided is the following polylactide resin composition.

A polylactide resin composition comprising:
100 parts by weight of a polylactide resin,
0.05 to 1.0 parts by weight of an organic acid anhydride;
0.05 to 1.0 parts by weight of a phosphorus-based compound, and
0.1 to 5.0 parts by weight of a branching agent of Chemical Formula 1:

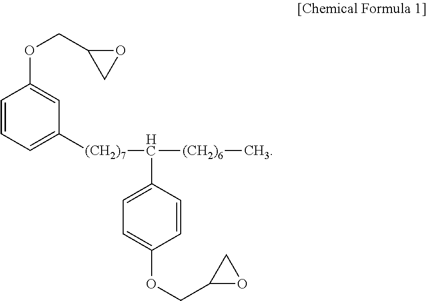

As used herein, the term “polylactide resin” is defined as comprehensively referring to a homopolymer or copolymer including a repeating unit represented by the following Chemical Formula.

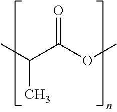

The polylactide resin can be prepared by a process including a step of forming the above repeating unit by the ring opening polymerization of the lactide monomer. The polymer obtained after the completion of such ring opening polymerization and the formation of the repeating unit can be referred to as the “polylactide resin”.

At this time, the term “lactide monomer” can be defined as follows. Typically, lactides can be classified into L-lactide consisting of L-lactic acid, D-lactide consisting of D-lactic acid, and meso-lactide consisting of an L-type and a D-type. Also, a mixture of L-lactide and D-lactide in a ratio of 50:50 is referred to as D,L-lactide or rac-lactide. Among these lactides, the polymerization proceeding only with either of L-lactide and D-lactide that have a high optical purity is known to yield an L- or D-polylactide (PLLA or PDLA) with a high stereoregularity. Such polylactides have a faster crystallization rate and also a higher crystallinity degree than a polylactide having a low optical purity. However, the term “lactide monomer” as used herein is defined to include all types of lactides regardless of the characteristic differences of lactides depending on their shapes and the characteristic differences of the polylactide resins obtained therefrom.

Meanwhile, the polylactide resin according to the present disclosure has a weight average molecular weight of 70,000 to 400,000 as an example.

As used herein, the term “organic acid anhydride” refers to a type of chemical compound derived by the removal of water molecules from an organic acid, and particularly, in the present disclosure, the organic acid anhydride reacts with the terminal hydroxy group (—OH) of the polylactide resin, which serve to make the terminal of the polylactide resin have a carboxyl group (—COOH). This further facilitates the reaction between the terminal carboxy group of the polylactide resin and the epoxy group present in the branching agent, which leads to a high degree of branching of the polylactide resin.

From this point of view, the organic acid anhydride is not particularly limited as long as it is a substance that reacts with the terminal hydroxy group (—OH) of the polylactide resin and makes the terminal of the polylactide resin have a carboxyl group (—COOH). Examples thereof include succinic anhydride, maleic anhydride, phthalic anhydride, or pyromellitic dianhydride.

Preferably, the organic acid anhydride is included in an amount of 0.06 parts by weight or more, 0.07 parts by weight or more, 0.08 parts by weight or more, 0.09 parts by weight or more, or 0.10 parts by weight or more; and 0.9 parts by weight or less, 0.8 parts by weight or less, 0.7 parts by weight or less, 0.6 parts by weight or less, 0.5 parts by weight or less, 0.4 parts by weight or less, 0.3 parts by weight or less, or 0.2 parts by weight or less, based on 100 parts by weight of the polylactide resin.

The branching agent of Chemical Formula 1 has a plurality of epoxy groups, and reacts via the epoxy groups with the polylactide resin having a terminal carboxy group (—COOH) to enable branching of the polylactide resin.

Preferably, the branching agent of Chemical Formula 1 is included in an amount of 0.2 parts by weight or more, 0.3 parts by weight or more, 0.4 parts by weight or more, 0.5 parts by weight or more, 0.6 parts by weight or more, 0.7 parts by weight or more, 0.8 parts by weight or more, 0.9 parts by weight or more, or 1.0 parts by weight or more; and 4.5 parts by weight or less, or 4.0 parts by weight or less, based on 100 parts by weight of the polylactide resin.

The phosphorus-based compound acts as a nucleophile and induces ring opening of the epoxy group of the branching agent of Chemical Formula 1 to cause chain extension. When the phosphorus-based compound is not added, the reaction between the polylactide resin and the branching agent of Chemical Formula 1 does not occur under general mixing conditions.

Preferably, the phosphorus-based compound is a compound of Chemical Formula 2:

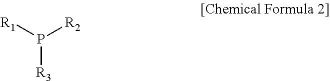

wherein in Chemical Formula 2:
R₁, R₂ and R₃ are each independently a C₁₋₂₀ alkyl; a C₃₋₂₀ cycloalkyl; phenyl that is unsubstituted or substituted with at least one C₁₋₂₀ alkyl or C₁₋₂₀ alkoxy; or benzyl.

Preferably, the phosphorus-based compound is triphenylphosphine, tri-m-tolylphosphine, diphenyl(para-tolyl)phosphine, tris(2,6-dimethoxyphenyl)phosphine, tris(4-methoxyphenyl)phosphine, trimesitylphosphine, tris-3,5-xylylphosphine, tricyclohexylphosphine, tribenzylphosphine, benzyldiphenylphosphine, or diphenyl-normal-propylphosphine, more preferably, triphenylphosphine.

Preferably, the phosphorus-based compound is included in an amount of 0.06 parts by weight or more, 0.07 parts by weight or more, 0.08 parts by weight or more, 0.09 parts by weight or more, or 0.10 parts by weight or more; and 0.9 parts by weight or less, 0.8 parts by weight or less, 0.7 parts by weight or less, 0.6 parts by weight or less, 0.5 parts by weight or less, 0.4 parts by weight or less, 0.3 parts by weight or less, or 0.2 parts by weight or less, based on 100 parts by weight of the polylactide resin.

According to another aspect of the present disclosure, provided is a branched polylactide resin, which is prepared by heat-treating the above-mentioned polylactide resin composition.

As described above, the branching agent contained in in the polylactide resin composition reacts with the polylactide resin having a carboxyl group (—COOH) terminal to enable branching of the polylactide resin, and a predetermined heat treatment progresses for the above reaction. A specific method for preparing the branched polylactide resin will be described later.

Branching of the polylactide resin progresses as described above, so that the molecular weight of the branched polylactide resin is higher than that of the polylactide resin contained in the polylactide resin composition. Preferably, the branched polylactide resin has a weight average molecular weight of 70,000 to 400,000. More preferably, the weight average molecular weight of the branched polylactide resin is 80,000 or more, 90,000 or more, 100,000 or more, 110,000 or more, 120,000 or more, or 130,000 or more; and 350,000 or less, 300,000 or less, 250,000 or less, 240,000 or less, 230,000 or less, 220,000 or less, 210,000 or less, or 200,000 or less.

Moreover, branching progresses as described above, so that the molecular weight distribution (Mw/Mn) of the branched polylactide resin is preferably 1.0 to 3.0.

Preferably, the branched polylactide resin has a Z-average molecular weight of 150,000 to 400,000. More preferably, the weight average molecular weight of the branched polylactide resin is 160,000 or more, 170,000 or more, 180,000 or more, 190,000 or more, or 200,000 or more; and 350,000 or less, 340,000 or less, 330,000 or less, 320,000 or less, 310,000 or less, 300,000 or less, 290,000 or less, or 280,000 or less.

According to yet another aspect of the present disclosure, provided is a method for preparing the branched polylactide resin described above, comprising the steps of:
1) mixing a polylactide resin and an organic acid anhydride at 170° C. to 200° C. (step 1); and
2) mixing the product of step 1 with the branching agent of Chemical Formula 1 and the phosphorus-based compound (step 2).

Step 1 is a step of reacting the terminal hydroxy group (—OH) of the polylactide resin with an organic acid anhydride to make the terminal of the polylactide resin have a carboxy group (—COOH), which is a step performed prior to the reaction of the polylactide resin and the branching agent.

Step 2 is a step of reacting the polylactide resin that has a carboxy group (—COOH) at the terminal due to step 1, with the epoxy group of the branching agent of Chemical Formula 1, wherein the phosphorus compound is added together for ring opening of the epoxy group, to prepare the branched polylactide resin according to the present disclosure.

### Advantageous Effects

The above-mentioned branched polylactide resin according to the present disclosure has a feature that it is highly branched and thus is improved in several physical properties, especially melt strength as compared to conventional polylactide resins, and can be applied to processes that were difficult to apply to conventional polylactide resins such as expanded foam.

### EXAMPLES

Below, embodiments of the present disclosure will be described in more detail with reference to examples. However, the following examples are for illustrative purposes only and are not intended to limit the scope of the present disclosure.

### Example 1

65 g of PLA (4032D from NatureWorks; weight average molecular weight of about 210,000), and 0.2 wt % of succinic anhydride based on the weight of the PLA was placed in a HAAKE mixer, and mixed at 60 rpm at 190° C. for 2 minutes. After stopping for a while, 3 wt % of the branching agent shown in Table 1 below and 0.2 wt % of TPP based on the weight of the PLA were added thereto, and mixed for 10 minutes to prepare a branched polylactide resin.

### Examples 2 to 12

Branched polylactide resins were respectively prepared in the same manner as in Example 1, except that the amounts of anhydride compound, TPP (triphenylphosphine) and branching agent were changed as shown in Table 1 below.

### Comparative Examples 1 to 4

Polylactide resins of Comparative Examples 1 to 3 were respectively prepared in the same manner as in Example 1, except that any one or more of an anhydride compound, TPP (triphenylphosphine) and a branching agent were not used as shown in Table 1 below. In addition, PLA (4032D from NatureWorks) used in the Examples was used as Comparative Example 4 as it was.

### Experimental Example

The degree of branching of the resins prepared in Examples and Comparative Examples were measured using MALS-GPC. Mw, Mz, PDI, and Mark-Houwink slopes were measured by MALS-GPC, and specific measurement conditions are as follows.
Column: PLgel mixed-B×2
Solvent: Tetrahydrofuran (Stabilized with BHT)
Flow rate: 1.0 ml/min
Sample concentration: 3.0 mg PLA/1.0 mL THE
Injection volume: 100 μl
Column temperature: 40° C.
Detector: Viscotek TDA 305
Data Processing: OmniSEC

The higher the values of Mw, Mz, and PDI, and the lower the values of the Mark-Houwink slope, show better branching, and the results are shown in Table 1 below.

TABLE 1

| | Anhydride | | Branching agent | | TPP | | | | Mark- |
|---|---|---|---|---|---|---|---|---|---|
| | | Content | | Content | Content | | | | Houwink |
| | Type | (wt %) | Type | (wt %) | (wt %) | Mw | Mz | PDI | slope |
| Example 1 | SA¹⁾ | 0.2 | NC- | 3.0 | 0.2 | 168.9k | 285.2k | 1.59 | 0.52 |
| | | | 514²⁾ | | | | | | |
| Example 2 | SA | 0.2 | NC- | 4.0 | 0.2 | 159.0k | 257.1k | 1.36 | 0.57 |
| | | | 514 | | | | | | |
| Example 3 | SA | 0.2 | NC- | 1.5 | 0.2 | 139.5k | 202.5k | 1.31 | 0.64 |
| | | | 514 | | | | | | |
| Example 4 | SA | 0.2 | NC- | 0.5 | 0.2 | 132.3k | 177.3k | 1.33 | 0.68 |
| | | | 514 | | | | | | |
| Example 5 | SA | 0.1 | NC- | 3.0 | 0.2 | 149.2k | 234.5k | 1.34 | 0.61 |
| | | | 514 | | | | | | |
| Example 6 | SA | 0.1 | NC- | 4.0 | 0.2 | 145.1k | 210.6k | 1.31 | 0.64 |
| | | | 514 | | | | | | |
| Example 7 | SA | 0.1 | NC- | 1.5 | 0.2 | 133.4k | 183.9k | 1.24 | 0.69 |
| | | | 514 | | | | | | |
| Example 8 | SA | 0.1 | NC- | 0.5 | 0.2 | 132.3k | 173.7k | 1.22 | 0.70 |
| | | | 514 | | | | | | |
| Example 9 | SA | 0.2 | NC- | 3.0 | 0.1 | 158.3k | 255.3k | 1.37 | 0.55 |
| | | | 514 | | | | | | |
| Example 10 | SA | 0.2 | NC- | 4.0 | 0.1 | 148.5k | 238.5k | 1.33 | 0.59 |
| | | | 514 | | | | | | |
| Example 11 | SA | 0.2 | NC- | 1.5 | 0.1 | 137.8k | 193.7k | 1.28 | 0.66 |
| | | | 514 | | | | | | |
| Example 12 | SA | 0.2 | NC- | 0.5 | 0.1 | 134.1k | 185.7k | 1.27 | 0.68 |
| | | | 514 | | | | | | |
| Comparative | SA | 0.2 | NC- | 3.0 | — | 155.4k | 219.9k | 1.28 | 0.61 |
| Example 1 | | | 514 | | | | | | |
| Comparative | — | — | NC- | 3.0 | 0.2 | 139.2k | 173.6k | 1.20 | 0.67 |
| Example 2 | | | 514 | | | | | | |
| Comparative | — | — | NC- | 3.0 | — | 143.4k | 178.9k | 1.20 | 0.71 |
| Example 3 | | | 514 | | | | | | |
| Comparative | — | — | — | — | — | 125.2k | 162.3k | 1.27 | 0.71 |
| Example 4 | | | | | | | | | |

¹⁾SA: Succinic anhydride
²⁾NC-514: NC-514 which is Cardolite's commercial product

1. A polylactide resin composition, comprising:
100 parts by weight of a polylactide resin;
0.05 to 1.0 parts by weight of an organic acid anhydride;
0.05 to 1.0 parts by weight of a phosphorus-based compound; and
0.1 to 5.0 parts by weight of a branching agent of Chemical Formula 1:

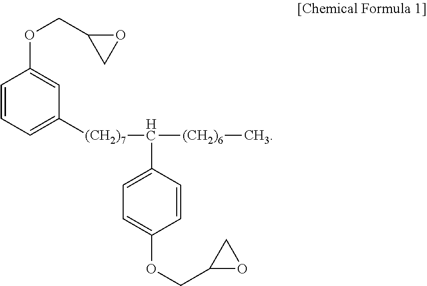

2. The polylactide resin composition of claim 1, wherein:
the organic acid anhydride is succinic anhydride, maleic anhydride, phthalic anhydride, or pyromellitic dianhydride.

3. The polylactide resin composition of claim 1, wherein:
the organic acid anhydride is included in an amount of 0.1 to 0.2 parts by weight.

4. The polylactide resin composition of claim 1, wherein:
the phosphorus-based compound is a compound of Chemical Formula 2: 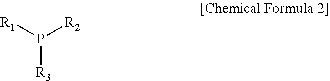
wherein in Chemical Formula b 2:
R₁, R₂ and R₃ are each independently a C₁₋₂₀ alkyl; a C₃₋₂₀ cycloalkyl; phenyl that is unsubstituted or substituted with at least one C₁₋₂₀ alkyl or C₁₋₂₀ alkoxy; or benzyl.

5. The polylactide resin composition of claim 1, wherein:
the phosphorus-based compound is triphenylphosphine.

6. The polylactide resin composition of claim 1, wherein:
the branching agent of Chemical Formula 1 is included in an amount of 2.0 to 4.0 parts by weight.

7. The polylactide resin composition of claim 1, wherein:
the polylactide resin has a weight average molecular weight of 70,000 to 400,000.

8. A branched polylactide resin, which is prepared by heat-treating the polylactide resin composition of claim 1.

9. The branched polylactide resin of claim 8, wherein:
the branched polylactide resin has a weight average molecular weight of 100,000 to 200,000.

10. The branched polylactide resin of claim 8, wherein:
the branched polylactide resin has a Z-average molecular weight of 150,000 to 400,000.

11. The branched polylactide resin of claim 8, wherein:
the branched polylactide resin has a molecular weight distribution (Mw/Mn) of 1.0 to 3.0.

12. A method for preparing a branched polylactide resin, the method comprising the steps of:
1) mixing a polylactide resin and an organic acid anhydride at 170° C. to 200° C. (step 1); and
2) mixing the product of step 1 with a branching agent of Chemical Formula 1 and a phosphorus-based compound (step 2):

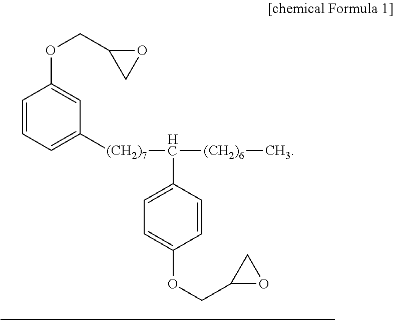

13. The method of claim 12, wherein:
a mixing time of step 1 is 30 seconds to 3 minutes.

14. The method of claim 12, wherein:
a mixing time of step 2 is 3 to 15 minutes.

15. The method of claim 12, wherein the phosphorus-based compound is a compound of Chemical Formula 2: 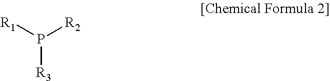
wherein in Chemical Formula 2:
R₁, R₂ and R₃ are each independently a C₁₋₂₀ alkyl; a C₃₋₂₀ cycloalkyl; phenyl that is unsubstituted or substituted with at least one C₁₋₂₀ alkyl or C₁₋₂₀ alkoxy; or benzyl.

16. The method of claim 12, wherein the organic acid anhydride is succinic anhydride, maleic anhydride, phthalic anhydride, or pyromellitic dianhydride.
